(19) United States
(12) Patent Application Publication
(10) Pub. No.: US 2023/0266831 A1
(43) Pub. Date: Aug. 24, 2023

(54) METHOD AND DEVICE FOR OBTAINING USER INPUT

(71) Applicant: Telefonaktiebolaget LM Ericsson (publ), Stockholm (SE)

(72) Inventors: Göran PEHRSSON, MALMÖ (SE); Fredrik DAHLGREN, LUND (SE); Alexander HUNT, TYGELSJÖ (SE); Andreas KRISTENSSON, SÖDRA SANDBY (SE)

(21) Appl. No.: 18/015,320

(22) PCT Filed: Jul. 10, 2020
(86) PCT No.: PCT/EP2020/069533

§ 371 Date: Jan. 9, 2023

(51) Int. Cl. G06F 3/0346; G06F 3/01; G06F 3/0488

(52) U.S. Cl. CPC G06F 3/0346; G06F 3/017; G06F 3/0488

(57) ABSTRACT

Embodiments of the present disclosure provide a method, a computer program product, and a device for obtaining user input to an application in a portable device including a touch detection area and one or more movement determining sensors. The method includes detecting first user input on the touch detection area within a time period, wherein the first user input is related to the application. The method further includes registering movement of the portable device within a predetermined space during said time period and causing the application to respond to second user input during said time period, wherein the second user input is obtained from the registered movement.

### TECHNICAL FIELD

The present disclosure relates to a method and device for obtaining movement generated user input and/or exercising movement generated user control. In particular, the disclosure relates to a method and device for obtaining user input to a context associated application in a portable device comprising a touch detection area and one or more movement determining sensors receiving.

### BACKGROUND

Over the last decade, so called touchscreens or touch panels, i.e., user interfaces activated through physical touching, are widely applied in various electronic products in all aspects of peoples work and life. Physical touchscreen functionality is today commonly used for smartphones, tablets, smartwatches or similar portable devices.

The physical touchscreens provide input and display technology by combining the functionality of a display device and a touch-control device. There are a variety of touch-control technologies to enable user input through a touch control interface, e.g., using resistive, capacitive, infrared, and electromagnetic sensors and technologies. User input through a physical touchscreen comprises touching a display area with one or several fingers or using an appliance specifically adapted for use on a touchscreen, e.g., a pen.

When applying the touchscreen technology to a portable device, e.g., a smartphone or smartwatch, user input is limited by the size of the touchscreen that needs to be of a size adapted to the size of the portable device, i.e., of a fairly small size. User input to the portable device is restricted to a small-size touchscreen area fitted to the portable device.

Consequently, there is a need to improve the ability to obtain user input in a portable device.

### SUMMARY

It is therefore an object of the present disclosure to provide a method, a computer program product, and a device for receiving user input that seeks to mitigate, alleviate, or eliminate all or at least some of the above-discussed drawbacks of presently known solutions.

This and other objects are achieved by means of a method, a computer program product, and a device as defined in the appended claims. The term exemplary is in the present context to be understood as serving as an instance, example or illustration.

According to a first aspect of the present disclosure, a method for obtaining user input to an application in a portable device comprising a touch detection area and one or more movement determining sensors is provided. The method comprises detecting first user input on the touch detection area within a time period, wherein the first user input is related to the application. The method further comprises registering movement of the portable device within a predetermined space during said time period and causing the application to respond to second user input during said time period, wherein the second user input is obtained from the registered movement.

Advantageously, the proposed method can be used to provide an expanded user input domain, i.e., enabling user input in a space larger than the physical size of the device. The proposed method provides a second gesture based user interface, UI, to interact outside the physical touch detection area. The expanded UI enables the user to interact and control various applications in the device. Thus, the proposed method allows user input also in an expanded, gesture based user interface that may be combined with first user input through the touch detection area. Thus, expanded, gesture based second user interface provides for a natural, intuitive extension of the physical touch display.

In some examples, the method of obtaining user input comprises activating the portable device to respond to second user input.

Thus, the expanded, gesture based second user interface provides may be activated upon demand thereby reducing the risk of inadvertent second user input prior to an intended transition into the expanded user interface.

In some examples, activating the portable device to respond to second user input comprises receiving, from the touch detection area, information relating to user activity in a direction toward a perimeter of the touch detection area; and/or detecting first user input at a perimeter of the touch detection area.

In some examples, the second user input is a gesturing movement of the portable device within reach of the user and the second user input is obtained by retrieving at least one gesture interpretation from a gesture library and applying the gesture interpretation to the gesturing movement.

In some examples, the application is a context associated application determined from a user context, wherein the user context is determined from one or more of a physical location, commercial location, and connected device of the user.

According to a second aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

A portable device comprising a touch detection area, one or more movement determining sensors, and processing circuitry, wherein the processing circuitry is configured to: detect first user input on the touch detection area within a time period, wherein the first user input is related to the application; register movement of the portable device within a predetermined space during said time period; and cause the application to respond to second user input during said time period, wherein the second user input is obtained from the registered movement.

In some examples, the portable device is a smartphone, a tablet, a smart watch or a wearable device. The word device is used to denote all of the above types of devices.

An advantage of some embodiments is an enablement of an expanded user input, allowing user input within a space unlimited by the physical size of the portable display, at the same time as the risk of inadvertent user input, e.g., mistaking gesturing movements as input control, is minimized.

Another advantage of some embodiments is that the user interface, UI, is intuitive, so that the user input obtained from movement of the portable device is experienced as a very natural extension to user input obtained through the touch detection area.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example implementation of a portable device with an expanded user interface for obtaining user input;

FIG. 2A and B disclose flowchart representations of example method steps for obtaining user input;

FIG. 3 discloses an example schematic block diagram of a portable device;

FIGS. 4-7 disclose example use cases;

FIG. 8 disclose an example computing environment.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is only for the purpose of describing particular aspects of the disclosure, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

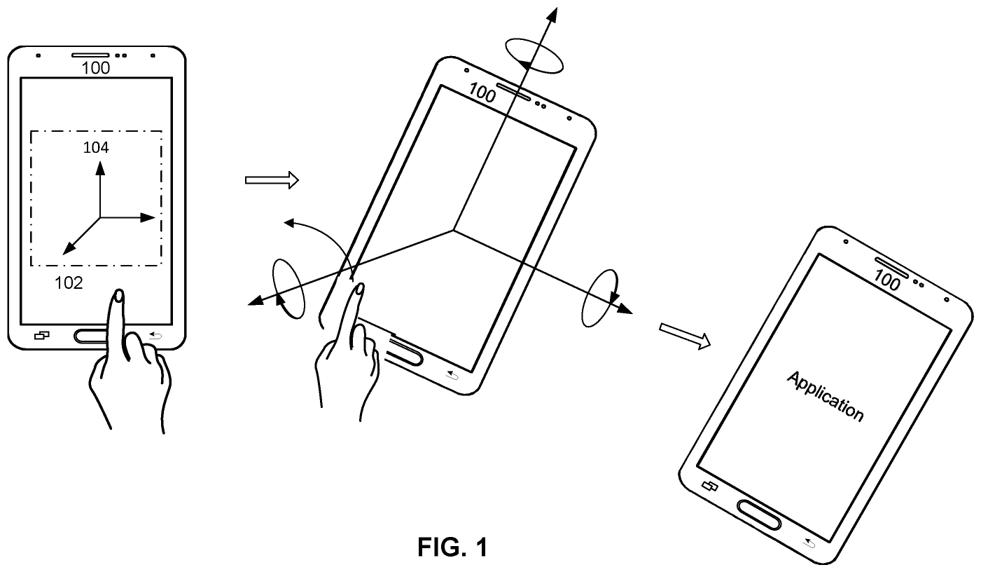

FIG. 1 discloses an example implementation of a portable device with an expanded user interface for obtaining user input and illustrates provisioning of user input to a portable device in a simplified scenario. In the disclosed scenario, a user is capable of providing user input to a portable device 100, e.g., a smartphone, a tablet, a smartwatch or a wearable device. As will be further explained below, the proposed solution enables an expanded user interface whereby movement, i.e., intuitive gesturing, is recognized as user input to the portable device. Thus, when a user performs a gesture with the portable device, i.e., inducing movement of the portable device, the device is configured to respond in a desired way to the movement.

Turning to FIG. 1, a portable device 100 comprises a touch detection area 102. The portable device 100 also comprises one or more movement determining sensors 104. The portable device 100 may be held in one hand while one or more fingers of the other hand touch the touch detection area 102. The hand holding the device initiates movement of the portable device 100.

Such movement of the device may result in a swipe input on the touch detection area 102. When the one or more fingers swipes out from the touch detection area 102, the portable device 100 may operate in a gesture detecting mode to receive user input by means of the one or more movement determining sensors 104. User input by means of the movement determining sensors 104 may be enabled in response to receipt of an activating user input via the touch detection area 102 or following an activating gesture recognized by the movement determining sensors 104. Consequently, when a finger is swiped out from the touch detection area 102, the user interface of the portable device 100 is expanded to receive also gesture derived user input, i.e., gestures of the hand holding the device. The expanded user interface, capable of receiving first user input via a touch detection area 102 and second user input via movement detection sensors 104, provide for a fast and intuitive expanded user interface.

Thus, in a simplified scenario, the user may physically move the portable device with one hand, e.g., by holding on to the device, while one or more fingers (or a pointer) of the other hand are in contact with the touch detection area 102. A gesturing movement of the physical device in one direction, will result in a finger movement across the touch area in an opposite direction causing the one or more fingers to make a swipe movement (swiping movement) on the touch detection area 102. The gesturing movement is registered by the one or more movement determining sensors 104. When the one or more fingers leave the touch detection area 102, user input mode may be switched or expanded in the portable device 100 so that second user input is retrieved from gesturing movements registered by the movement determining sensors 104. The portable device 100 may of course be configured to operate with a combination of first and second user input concurrently or to switch from first to second user input mode following an activating operation, e.g., the above disclosed swipe movement across the touch detection area. Activation of the gesture detecting mode may also require further distinctive gesturing of the portable device 100, i.e., moving the device in a given way to enable user input through an expanded gesture interface. Accordingly, a natural movement of the device causes the device to respond in a certain way, making the expanded user interface fast and intuitive.

In one embodiment of the invention a swipe movement is caused mainly by the movement of the device (portable device), and less by moving the finger touching the touch sensitive area, until the finger touching the touch sensitive area reaches a certain place or area on the touch sensitive area, like for example reaching the border of the touch sensitive area, causing the device to take action. One action could be a specific action like for example change the menu and or screen contents. Another action could be to change mode so that the device is being further receptive to a subsequent movement of the device, where the subsequent movement of the device could cause specific action of the devices (like e.g. changing menu or screen contents). The example of changing menu or screen contents is just one example of a specific action the device could take.

In order to facilitate the description of the above aspect of the invention the following terminology is used:
the swipe movement, meaning the swiping of one or more fingers, or other object on the touch detection area, being the first user input as detected by the touch detection area. Please note that the swipe movement can be caused by a finger movement, a device movement or a combination of the two.
the device movement (gesture movement of the device), meaning the movement of the device as caused typically by the movement of the hand holding the device, causing second user input as detected by one or more movement determining sensors.
the finger movement, meaning the movement of one or more fingers, or one or more other objects, touching the touch detection area.

Please note that, in the case of using a flat touch sensitive area, the swipe movement is limited to two dimensions (the plane of the touch sensitive area). The device movement and the finger movement can both be three dimensional. The projection of the device movement on the plane of the touch sensitive area is two dimensional. The projection of the finger movement on the touch sensitive area is two dimensional.

The touch detection area can in the wider scope determine touch, hovering and/or be pressure sensitive.

We will now discuss some aspects of relative movement between;
the finger, meaning the one or more fingers, or other object or objects, touching the touch detection area,
the device.

If there is no relative movement between the finger and the device no swipe movement will be caused. If there is a relative movement between the finger and the device, a swipe movement will be caused as long as the finger does not leave the touch detection area.

This application will focus on the relative movements and not cover things like for example the impact on the device caused by the person operating the device while for example riding a train that is accelerating. How to solve the related technical issues to be able to work with only relative movements are outside the scope of this application.

The details of how to recognize a swipe movement, meaning a swipe movement that means something to an application and/or the operating system, is outside the scope of this application. This mapping can be done in a variety of ways, one way could be to compare the swipe movement with one or more valid swipe movements stored in one or more libraries of swipe movements. A swipe movement could be valid for one application and/or the operating system and not valid for another application and/or the operating system. Exactly how the mapping is done and how the information is stored is outside the scope of this application. To recognize a swipe movement could also be expressed as to map a swipe movement on a valid swipe movement or to interpret a swipe movement as a valid swipe movement.

How to recognize a device movement (a gesture movement of the device), meaning how to map a device movement on a valid device movement meaning a device movement that means something to an application and/or the operating system is also outside the scope of this application. The corresponding considerations as for how to recognize swipe movements apply. To recognize a device movement could also be expressed as to map a device movement on a valid device movement or to interpret a device movement as a valid device movement.

It is in real life very difficult or impossible for a user to make a perfect swipe movement or a perfect device movement, with perfect meaning that they are exactly matching a geometrical pattern that the user of the device tries to achieve. It is for example very difficult or impossible to swipe a perfect circle with a certain radius, instead the device has to try to determine if the swipe movement is “close enough” to be interpreted/accepted as a circle or any other pattern that is relevant for the application and/or operating system of a device. The same goes for the gesture movements. These decisions will be based on a set of criteria.

How to solve the problem of how a device is interpreting and accepting a swipe movement as a valid swipe movement that is suitable as input for the device at, as well as how to solve the problem of how a device is interpreting and accepting a device movement (gesture movement of the device) as a device movement that is suitable as input for the device are outside the scope of this application. This application focus on how to handle the combination of the two.

A few basic examples will now be discussed. To facilitate the understanding, the discussion is based on the following “basic assumptions for the scenario”:
The device is shaped as a typical smartphone (meaning with a basically flat touch sensitive area).
The device is held in front of the user in a fully horizontal position, meaning that the touch sensitive area of the device points upwards
The finger stays on the touch sensitive area all the time, unless specifically stated otherwise.
The device moment:
   only takes place in the horizontal plane, meaning that it can be
      moved away from the user and/or towards the user
      moved to the left and/or to the right
   can't take place in the vertical plane, meaning that
      it can't be moved neither up nor down
   does not allow the device to be tilted and/or rotated, etc. unless otherwise specifically stated.

A first example: a device movement in one direction, for example away from the user, while holding the finger in an approximately fixed position, will result in the fingers swiping across the touch detection area in an opposite direction, causing the one or more fingers to make a swipe movement on the touch detection area, that in this example (if now using the device as a reference point) can be said to be in the direction towards the user.

A second example: A device movement in one direction, for example away from the user, while at the same time making a finger movement in the same direction, in this case away from the user, with approximately the same speed as the device movement, will not result in any swipe movement on the touch detection area.

A third example: a device movement in one direction, for example away from the user, while moving the fingers in a perpendicular direction, for example to the right, with the same speed as the device movement will cause the fingers to make a swipe movement in a diagonal fashion.

As can be seen a wide variety of combinations of movements are of course possible, even more so if neither the device movement nor the finger movement is restricted to two dimensions.

It should be noted that the device movement and the finger movement will together determine what the swipe movement will look like.

The discussion will now focus on how to determine whether a swipe movement is mainly caused by the device movement or by the finger movement.

By basing its actions on both the device movement and the swipe movement (which is caused by the device movement and the finger movement) the device can get a widely expanded user interface.

One important feature will be to be able to distinguish between the following two example cases; holding the finger approximately still while moving the device away from the user, moving the finger towards the user while holding the device approximately still. Both of these cases will cause a swipe movement towards the user, in a similar fashion. In real life it is very hard for a user to hold something perfectly still, here instead one could talk about whether the swipe movement is generated mainly by the device movement or mainly by the finger movement.

For the next few examples the “basic assumptions for the scenario” stated earlier on apply with the following differences:
The device can only be moved away from the user and/or towards the user
   We call this direction the x-axis, with positive values going away from the user.

To facilitate the understanding, some additional terminology will be introduced:
V_{Device}: The velocity of the Device Movement
   V_{Device,x}: The velocity of the Device Movement along the x-axis.
      TD_{Device,x}: The travelled distance (change of position) of the device along the x-axis when moving with the velocity V_{Device,x} during a time T.
V_{Finger}: The velocity of the Finger Movement
   V_{Finger,x}: The velocity of the Finger Movement along the x-axis.
      TD_{Finger,x}: The travelled distance (change of position) of the finger along the x-axis when moving with the velocity V_{Finger,x} during a time T.

V_{swipe}: The velocity of the Swipe Movement
V_{swipe,x}: The velocity of the Swipe Movement along the x-axis.
   TD_{swipe,x}: The travelled distance (change of position) of the swipe along the x-axis when moving with the velocity V_{Swipe,x} during a time T.

The movement detection sensors are detecting acceleration which then has to be converted into velocity.

Whether a device base it's decisions on instantaneous velocity or average velocity is more a matter of implementation and can have its pros and cons in different situations. For the matter of simplicity, we discuss average velocity if not otherwise explicitly stated. One should also note that; instead of basing its decisions on velocity, the device could base its decisions on distances or times.

Below follow a few examples, where the device would act on user input consisting of the detection of the device being moved away from the user, detecting a a swipe movement towards the user, and also determining whether the swipe movement is mainly caused by the device movement. The values used in the examples are just mere examples showing the mechanics and logic. It would be up to an implementation to select suitable values.

The first examples below focus on when the finger is following (moving in the same direction as) as the device movement
The user moves the device away from him, with the velocity V_{A,x} while he holds his finger still.

V_{Device,x}=V_{A,x}, V_{Finger,x}=0, V_{Swipe,x}=−(V_{Device,x}−V_{Finger,x})=−V_{A,x}
Here the swipe movement is entirely caused by the device movement
The application would typically act on this case
The user moves the device away from him, with the velocity V_{A,x} while he lets his finger (intentionally or unintentionally) “follow” the device slowly, let's say with 10% of V_{A,x}.

V_{Device,x}=V_{A,x}, V_{Finger,x}=0.1 V_{A,x,} V_{Swipe,x}=−(V_{Device,x}−V_{Finger,x})=−0.9V_{A,x}
Here one could argue that the swipe movement is mainly caused by the device movement
The application would typically act on this case
The user moves the device away from him, with the velocity V_{A,x} while he lets his finger (intentionally or unintentionally) “follow” the device quite fast, let's say with 90% of V_{A,x}.

V_{Device,x}=V_{A,x,} V_{Finger,x}=0.9V_{A,x}, V_{Swipe,x}=−(V_{Device,x}−V_{Finger,x})=−0.1V_{A,x}
Whether or not this case would be useful as input for an application can be discussed. It can also be discussed whether or not the swipe movement is mainly caused by the device movement.
One should note that if the finger would follow the device with the same velocity as the device, no swipe movement would be caused (which means that the application, as stated further above, would not act on this case).
One should also note that if the finger would move faster than the device, it would cause a swipe movement away from the user (which means that the application, as stated further above, would not act on this case)

It could be useful for some applications to set a threshold-for-following (T_{follow,x}) value, for the velocity of the finger “following” the device movement as discussed above, that the device could use to distinguish between swipe movements caused mainly by the device movement and not mainly caused by the device movement. Such a threshold value could be expressed in various ways. One way could be to let T_{follow,x} state the maximum percentage of V_{Device,x} that V_{Finger,x} can have for for the device considering the caused swipe movement to be mainly caused by the device movement. Other ways could be to let the threshold for following represent a velocity (e.g. V_{B,x}) rather than a percentage of the V_{Device,x} (which was V_{A,x} in the examples above).

Below follows a few more cases where the finger instead of following (moving in the same direction as the device movement) rather moves in the opposite direction to the device movement.
The user moves the device away from him, with the velocity V_{A,x} while he lets his finger (intentionally or unintentionally) “slide towards himself” slowly, let's say with 10% of V_{A,x}.

V_{Device,x}=V_{A,x,} V_{Finger,x}=−0.1 V_{A,x,} V_{Swipe,x}=−(V_{Device,x}−V_{Finger,x})=−1.1V_{A,x}
Here one could argue that the swipe movement is mainly caused by the device movement
The application would typically act on this case
The user moves the device away from him, with the velocity V_{A,x} while he lets his finger (intentionally or unintentionally) “slide towards himself” with a velocity that is a significant part of the velocity of the device moving away, let's say with 50% of V_{A,x}.

V_{Device,x}=V_{A,x,} V_{Finger,x}=−0.5 V_{A,x,} V_{Swipe,x}=−(V_{Device,x}−V_{Finger,x})=−1.5V_{A,x}
Here it might be more difficult to argue that the swipe movement is caused mainly by the device movement, since the device movement and the finger movement both contribute significately.

The user moves the device away from him, with the velocity V_{A,x} while he lets his finger (intentionally or unintentionally) “slide towards himself” faster than the device moves away, let's say with 150% of V_{A,x}.

V_{Device,x}=V_{A,x,} V_{Finger,x}=−1.5 V_{A,x,} V_{Swipe,x}=−(V_{Device,x}−V_{Finger,x})=−2.5V_{A,x}
Here one could argue that the swipe movement is caused mainly by the finger movement rather than by the device movement.

It could be useful, or even necessary, for applications to set a threshold-for-opposite (T_{opposite,x}) value, for the velocity of the finger moving in the opposite direction of the device movement as discussed above, that the device could use to distinguish between swipe movements caused mainly by the device movement and not mainly caused by the device movement. Such a threshold value could be expressed in various ways. One way could be to let T_{opposite,x} state the maximum percentage of V_{Device,x} that V_{Finger,x} can have in the opposite direction of V_{Device,x} for the device considering the caused swipe movement to be mainly caused by the device movement. Other ways could be to let the threshold for following represent a velocity rather than a percentage, in the same way as described above when discussing T_{follow,x}.

T_{follow,x} and T_{opposite,x} (if both are present) does not necessarily have to have the same value (or the same absolute value, considering they are in the opposite direction of each other), or even be expressed in the same physical quantity.

The comparison between the velocities of the device movement and the swipe movement could also be done as a comparison between distance travelled for the device and the swipe.

The most basic example is when the device moves away from the user at a certain velocity (V_{A,x)}, and the finger does not move, In this case it is easy to realize that the device has moved the same distance as the length of the swipe, but in the opposite direction. We can say that the device movement is a complementary movement to the swipe movement. We can also see that the travelled distance of the device and the travelled distance of the swipe are equally long in opposite directions, thus one can also say that the scale factor along the x-axis is 1.

TD_{Device,x}=−TD_{Finger,x}=−TD_{Swipoe,x}

TD_{Device,x}=−TD_{Swipoe,x}

TD_{Device,x}=−ScaleFactor×TD_{Swipoe,x}

ScaleFactor=1

Let's now discuss the case when the device moves away from the user at a certain velocity (V_{A,x)}, and the finger follows the device (moves in the same direction as the device), in this example the finger follows the device at a velocity that is a third of the velocity of the device.

$${V}_{Device , x} = {V}_{A , x} , {V}_{Finger , x} = \frac{1}{3} {V}_{A , x} \\ {V}_{Swipe , x} = - ( {V}_{Device , x} - {V}_{Finger , x} ) = - \frac{2}{3} {V}_{A , x}$$

If locking at the distance travelled during a time T, for the device and the swipe, the following will apply. Assume we want the length (travelled distance) of the swipe (TD_{Swipe,x}) to be a certain length, let's say TD_{B,x}. Then:

$${Td}_{Swipe , x} = {TD}_{B , x} \\ {TD}_{Device , x} - {TD}_{Finger , x} = - {TD}_{Swipoe , x} \\ {TD}_{Device , x} - \frac{1}{3} {TD}_{Device , x} = - {TD}_{B , x} \\ {TD}_{Device , x} = - \frac{3}{2} {TD}_{B , x} \\ {TD}_{Device , x} = - ScaleFactor \times {TD}_{Swipoe , x} \\ {ScaleFactor}_{, x} = \frac{3}{2}$$

Here it can be seen that since the finger follows the device, the device has to travel a longer way than the swipe that is produced. We can say that the device movement is a complementary movement to the swipe movement. We can also see that the travelled distance of the device and the travelled distance of the swipe have different lengths and in opposite directions, thus one can also say that the scale factor along the x-axis is

$$\frac{3}{2} .$$

Let's now discuss the case when the device moves away from the user at a certain velocity (V_{A,x)}, and the finger moves in the opposite direction of the device, in this example the finger moves in the opposite direction of the device at a velocity that is a third of the velocity of the device. Here on can understand that the device does not have to move as far as the length of the swipe since the finger contributes to the swipe moving in the opposite direction of the device. In analogy with the above one one can calculate the scale factor along the x-axis.
ScaleFactor_{,x}=¾

Here one can understand that the instead of using thresholds for velocities, one could use thresholds for the distance travelled, which could be expressed as thresholds for the scale factor. One could use a threshold for then the finger is following the device, ScaleFactorThresholdFollowing_{,x}. and another when the finger is moving in the opposite direction of the device, ScaleFactorThresholdOpposite_{,x}, The thresholds could have different values or have the same value and then being regarded as one threshold ScaleFactorThreshold_{,x}.

The discussion above can be generalized to cover finger movements and device movements in three dimensions. The swipe movements will however, on a flat surface of the touch sensitive area of the device, be a movement in two dimensions, the two dimensions of the touch sensitive area. One can of course imagine touch sensitive areas which are not flat for certain devices. One could decide to define the coordinate system in different ways. One way is to set a fix point in the room, so that if the device moves and is turned around the plane of touch sensitive area would move around in the coordinate system. Another way is to fix the coordinate system to the touch sensitive area. Which of these ways is used, or any other way for that matter, is not of crucial importance, it will just affect the way the calculations are done.

One important thing is however to realize that device movements can be projected on the plane of the touch sensitive area. One also has to realize that more than one three dimensional device movement will have the same two dimensional projection on the plane of the touch sensitive area.

The discussions above has mostly focused on a swipe movement in a straight line in one direction caused mainly by a device movement in a straight line in an opposite direction. For each two-dimensional swipe movement there exist an opposite two-dimensional movement, which also can be referred to as the complementary movement. This complimentary two-dimensional movement represents the two-dimensional projection, in the same plane as the touch detection area, of the device movement that the device has to make in order to cause the swipe movement. The complimentary two-dimensional movement can be constructed from a 180 degrees rotation of the swipe movement along the plane of the touch detection area. A simple way to see it is to imagine a paper lying on the touch screen, marked up left, up right, down left and down right aligned with the corresponding corners of the touch detection area. The paper contains a drawing of the swipe movement. After the 180 degrees rotation the paper would be placed with its up left aligned with the down right of the touch detection area, the up right aligned with the down left of the touch detection area, the down left aligned with the up righ of the touch detection area, the down right aligned with the up left of the touch detection area. And now the paper would contain a drawing of the two dimensional projection, on the plane of the touch detection area, of a device movement that would cause the swipe movement. Please note that several different three dimensional device movements could have the same projection, which would allow for several ways of moving the device as long as the finger is still touching the touch detection area. Whether the device would act on these different device movements in the same way, or in different ways would be up to the application. The complementary movement is basically a rotated version of the same shape as the swipe movement. As has been shown further above the complementary movements can be either “larger” or “smaller” or “the same size” as the swipe movement depending on the finger movement, if any. The application could use the relative velocities, and/or the travelled distances, scale factors, etc., of the projection of the device movement and the swipe movement, as has been discussed above, to determine whether the swipe movement is mainly caused by the device movement. This could include one or more thresholds as has been covered above, being thresholds for velocity or for the distance travelled (length), scale factors, etc. of the device moment projected on the same plane as the touch detection area in comparison to the swipe movement. In different embodiments the comparison could be made on the swipe movement or on the compliment to the swipe movement. The application could decide whether it should check and act on the swipe movement, the device movement or both, and to what extent.

The device could obtain a valid swipe movement from a library or other database, and then create the complementary valid two dimensional device movement from the valid swipe movement. The device could also do it the other way around, obtaining a valid two dimensional device movement from a library or other database, and then create the complementary valid swipe movement from the valid two dimensional device movement. The device could also obtain a valid three dimensional device movement from a library or other data base, and then create the valid two dimensional device movement by projecting the valid three dimensional device movement on the plane of the touch sensitive area. The device could also obtain a valid swipe movement and the complementary valid two dimensional device movement, from a library or other database, thus omitting the step of creating one from the other. The same apply to the valid three dimensional device movement.

When a device has detected a valid swipe movement mainly caused by a device movement, and that also a triggering event is detected, the device should take action. The triggering event could for example be that the swipe movement reach a specific area in the touch sensitive area or the border of the touch sensitive area. The action could be a specific action related to the application and/or the operating system, it could comprise things like changing menu or screen contents. The action could also be to change mode and be further receptive to subsequent device movement, and when a subsequent device movement has been interpreted as a valid subsequent device movement a specific action related to the application and/or operating system, could be taken, the specific action could comprise things like changing menu or screen contents.

As an example of the above could be that a user of a device wants to show something to another person, like for example a ticket for a train. In one embodiment the user could hold the finger still and move the device towards the other person causing a swipe movement, and when the finger reach the border of the touch sensitive area the ticket will be shown on the screen.

In another embodiment the user could hold the finger still and move the device towards the other person causing a swipe movement, and when the finger reach the border of the touch sensitive area, the device change mode and will be receptive subsequent device movements, and if the subsequent device movement is recognized as a certain valid device movement the ticket will be shown on the screen. If the subsequent device movement is recognized as another valid device movement possibly another specific action could be taken.

In one embodiment a method for detecting a swipe movement, caused by a combination of a device movement and a finger movement, can be expressed as.

A method for obtaining user input to an application in a portable device (100) comprising a touch detection area (102) and one or more movement determining sensors (104), wherein the method comprises,
detecting first user input on the touch detection area (102), representing a swipe movement, within a first time period, and
detecting (S12) second user input obtained from one or more of the, one or more, movement determining sensors, representing a device movement, within the first time period, and
detecting a triggering event, and
when the swipe movement is interpreted as a valid swipe movement and the device movement is interpreted as a valid device movement, cause the device to take action.

The method above where further the triggering event comprises the swipe movement reaching a predefined part of the touch sensitive area.

The method above where further the valid swipe movement is obtained from a library or other database, and the device movement is interpreted as a valid device movement if the two dimensional projection of the device movement on the plane of the touch sensitive area is interpreted as a valid complementary movement to the valid swipe movement.

The method above where further the valid complementary movement to the valid swipe movement, comprises the valid swipe movement rotated 180 degrees along an axis perpendicular to the touch sensitive area, scaled with a scale factor.

The method above where further the scale factor is (1−Scale Factor Threshold)<=scale factor<=(1+Scale Factor Threshold), where the scale factor threshold is chosen to indicate that the swipe movement is mainly caused by the device movemenet.

The method above where further the action taken by the device is to change menu or screen contents.

The method above where further the action taken by the device is to be receptive to detecting (S12) second user input obtained from one or more of the, one or more, movement determining sensors, representing a subsequent device movement, within a second time period, where the second time period is after the first time period.

The method above where further when a detected subsequent device movement is interpreted as a valid subsequent device movement, cause the device to change menu or screen contents.

As illustrated in FIG. 1, the portable device 100 is configured to obtain user input, e.g., user input to an application executed in the portable device 100. In some examples, the applications may have a user context association, e.g., associated to a physical or commercial user context, or a user context determined from one or more connected device. In some examples, a context associated application comprises an application determined based on a user context. For example, a physical location of a user may be used to determine the user context. If the user is in a restaurant, and the user performs the swipe gesture and also performs a movement of the portable device 100, then the portable device 100 determines that the user is in the restaurant and may automatically enable a payment application which allows the user to make a payment at the restaurant. If the user is providing user input at an airport, railway station other i.e., in a context of transportation boarding, a boarding card may be reflected. Thus, the various embodiments of the disclosure provides a method and a device for receiving a user input to enable or invoke an application, e.g., a context associated application that allows the user to operate the application in accordance with the user context.

The portable device 100 includes a touch detection area 102, which may comprise a touchscreen configured to receive first user input. For example, such first user input includes various touch interactions e.g., scrolling, pinching, dragging, swiping, or the like which are performed on the 10 touch detection area 102 of the portable device 100.

Once the expanded user interface has been activated, user input may also be obtained through movement of the portable device 100. Such user input enables interaction with the portable device 100, e.g., with applications of the portable device 100, through the touch detection area 102 and/or through movement of the portable device 100.

As illustrated in FIG. 1, a user may interact with the portable device 100 by providing first user input through a touch interaction, e.g., by performing a swipe gesture on the touch detection area 102 as illustrated. Within a time period comprising the first user input, the user may then provide second user input by rotating the portable device 100 thereby causing movement of the portable device 100. Thus, the portable device 100 receives first user input, e.g., by means of swipe gesture on the touch detection area 102 and receives second user input, e.g., by means of movement of the portable device 100. Additionally, the portable device 100 may be configured to determine a user context, e.g., based on first user input and the second user input or based on input from applications of the portable device. Further, the portable device 100 may be configured to provide user input to a context associated application in the portable device 100 based on the first user input, the second user input and/or a determined user context.

The portable device 100 may include various modules configured for obtaining the user input as described above. The portable device 100 and the various modules of the portable device 100 will be further detailed in conjunction with figures in later parts of the description.

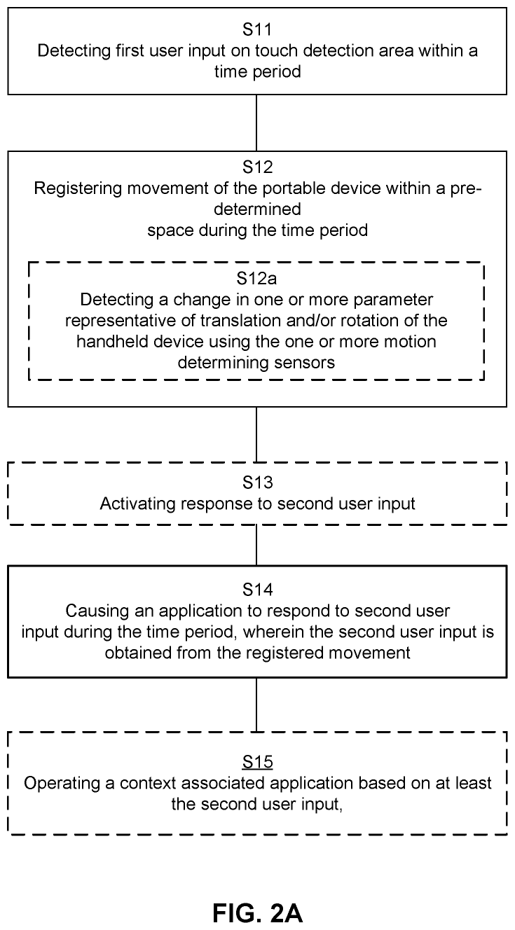

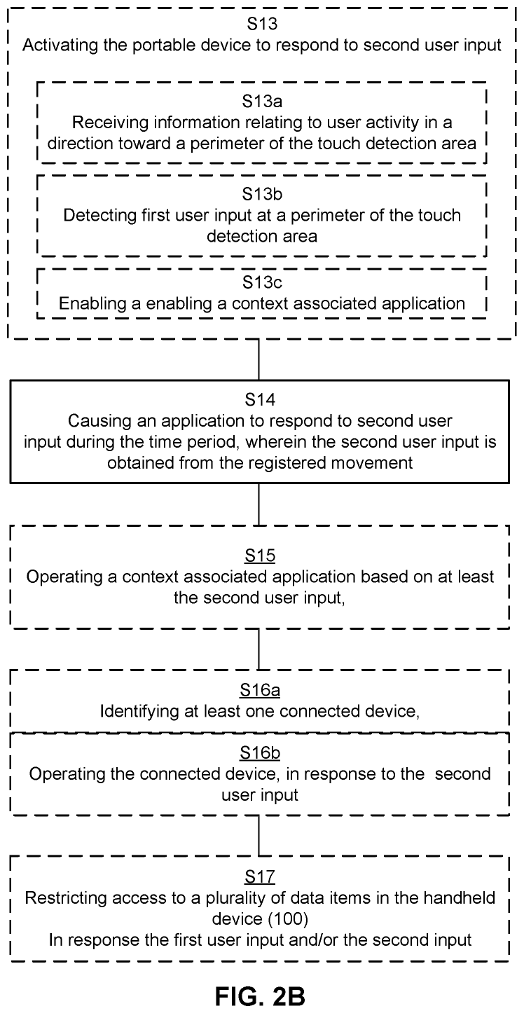

FIG. 2A discloses a flowchart illustrating example method steps implemented in a portable device 100, e.g., a portable device 100 as illustrated in FIG. 1, for obtaining user input. The portable device 100 a touch detection area 102 and one or more movement determining sensors 104. The method comprises detecting S11 first user input provided by a user on the touch detection area 102 within a time period, wherein the first user input is related to the application. The one or movement determining sensors 104 registers S12 movement of the portable device 100 within a predetermined space, e.g., a space within reach of the user, during said time period. Based on the first user input and the registered movement, the application is caused to respond to second user input during said time period, wherein the second user input is obtained from the registered movement.

Thus, the method comprises detecting S11 first user input on the touch detection area 102 within a time period, e.g., detecting first user input at a time instance initiating a time period. For example, the first user input may include touch interaction in the form of a swipe gesture, a drag gesture, a pinch gesture, or the like which is performed on the touch detection area 102. Further, such touch interaction may be performed with one finger, using multiple fingers or using a pointer device. The time period may be configurable in accordance with requirements of the portable device 100, the movement detection sensors 104, or an application run on the portable device 100. Thus, the first user input is detected on the touch detection area 102 within the time period; the first user input being related to the application run on the portable device 100, e.g., invoking or activating the application on the portable device 100.

In an embodiment, a user context is established, and the application is a context associated application determined from the user context. Accordingly, detecting first user input on the touch detection area 102 within a time period may comprise determining a context associated application determined from a user context. In some examples, a user context is determined from one or more of a physical location, commercial location, and one or more connected devices of the user as previously explained. The context of the user may also be determined based on the first user input, e.g., in response to the user initiating a touch activation of an application. That is, the portable device 100 may identify the context associated application in response to the first user input. For example, when the user performs a swipe gesture on the touch detection area 102, the portable device 100 identifies context associated application that may have a user context association, e.g., associated to a physical or commercial user context, or a user context determined from one or more connected device. In some examples, a context associated application comprises an application determined based on a user context. For example, a physical location of a user may be used to determine the user context. If the user is in a restaurant, at an airport, railway station other i.e., the user context may be determined from this presence in a restaurant, airport or railway station.

At step S12, the method comprises registering movement of the portable device 100 within a pre-determined space during the time period. For example, the user may flip the portable device 100, rotate the portable device 100, shake the portable 100 or the like which causes the portable device 100 to move from its initial position within the pre-determined space; the predetermined space representing a space surrounding the portable device 100 and within reach of the user, i.e., within the user's arm length reach (i.e., the user holding the device, is capable of causing movement of the portable device 100 by performing a gesture). In some examples, the movement is a gesturing movement of the portable device 100 within reach of the user. These movements of the portable device 100 are tracked by the movement determining sensors 104 equipped in the portable device 100 and registered for subsequent processing. Example movement determining sensors 104 comprises accelerometers, gyroscopes, orientation sensors, inertial sensors, or the like which are able of determining translation, rotation and a change in orientation of the portable device 100 in the pre-determined space around the portable device 100. The movement determining sensors 104 may continuously register the movements of the portable device 100, e.g., register various positions of the portable device 100 at discrete instances with frequent periodicity.

Thus, the movement determining sensors 104 are configured to continuously register the translation, rotation or change in orientation of the portable device 100. In some examples, registering movement of the portable device 100 within the pre-determined space during the time period may comprise detecting a change in one or more parameters representative of translation and/or rotation of the portable device 100 using the one or more movement determining sensors 104. For example, the user may flip the portable device 100 from landscape mode to portrait mode, move the portable device 100 along a table, hand the portable device 100 over to another user, push the portable device 100 to the side of a desk making space for other objects e.g. a laptop, and/or hand the portable device 100 over to another user thereby invoking movement registration. The movements of the portable device 100 such as translating the portable device 100 and/or rotating the portable device 100 causes a change in the one or more parameters, which are registered using the movement determining sensors 104.

In some examples, registering S12 movement of the portable device 100 within a predetermined space during the time period comprises detecting a change in one or more parameters representative of translation and/or rotation of the portable device 100 using the one or more determining sensors 104.

In some examples, the method of obtaining user input comprises activating S13 the portable device 100 and/or application to respond to second user input. Information relating to user activity in a direction toward a perimeter of the touch detection area 102 may be received S13a from the touch detection area 102. First user input at a perimeter of the touch detection area 102 may also be detected S13b to activate the portable device 100, e.g., the application executed in the portable device 100, to respond to second user input. In some examples, the steps of activating the portable device 100 to respond to second user input also comprises enabling the context associated application.

Turning back to the scenario of FIG. 1, activating S13 the portable device to respond to gesturing movement, i.e., second user input, may be achieved when the user physically move the portable device with one hand and touches the touch detection area with the fingers on the other hand. Thus, activating S13 may be achieved by the user holding onto the device, while one or more fingers (or a pointer) of the other hand are in contact with the touch detection area 102 and then quickly effecting the physical move of the portable device 100. A gesturing movement of the physical device, i.e., portable device 100, in one direction, will result in a finger movement across the touch area in an opposite direction causing the one or more fingers to make a swipe movement on the touch detection area 102. The gesturing movement is registered S12 by the one or more movement determining sensors 104 as previously disclosed. When the one or more fingers leave the touch detection area 102, user input mode may be switched or expanded in the portable device 100 so that second user input may be retrieved from gesturing movements registered by the movement determining sensors 104, i.e., causing an application of the portable device 100 to receive second user input as will be further explained below. The portable device 100 may be configured to operate with a combination of first and second user input concurrently or to switch from first to second user input mode following the activating step S13, e.g., the above disclosed swipe movement across the touch detection area. Activating S13 of the gesture detecting mode may also require further distinctive gesturing of the portable device, i.e., moving the device in a given way to enable user input through an expanded gesture interface. Accordingly, a nature movement of the device causes the device to respond in a certain way, making the expanded user interface fast and intuitive.

The method of obtaining user input also comprises causing S14 the application, e.g., the context associated application, to receive second user input during the time period based on the registered movement, i.e., the second user input being obtained from the registered movement. Thus, the second user input may be determined in accordance with the registered movement and may comprises pre-defined gestures, e.g., from a gesture library. For example, the second user input may be proportional to the registered movement. In some examples, the second user input is a gesturing movement of the portable device 100 within reach of the user and wherein the second user input is obtained by retrieving at least one gesture interpretation from a gesture library and applying the gesture interpretation to the gesturing movement. In some examples, the first input and the second input may detect at least in part concurrently on the portable device 100 during the time period. In other examples, the first user input and second user input are detected at least in part sequentially on the portable device 100, wherein the first user input is detected at a time instance initiating the time period.

FIG. 2B discloses further example method steps as implemented in the portable device 100, e.g., a wireless device. At step S15, the method comprises operating the context associated application based on at least the second user input. In some examples, obtaining user input to the context based application comprises receiving first user input through the touch detection area 102 and receiving second user input registered by the movement determining sensors 104. For example, when the user is about to board a cab and performs a swipe gesture as the first user input on the touch detection area 102, the cab application may enable display of a boarding pass when moving the portable device 100 to display a boarding pass presented on the portable device 100. Thus, in response to a combination of first user input and second user input, the cab application may be enabled and a boarding pass is displayed on the portable device 100.

In another example, operating S15 of the context associated application comprises making a payment at a restaurant, the restaurant representing the user context. In another example, when the user is engaged in a jogging activity and the user performs a swipe gesture and rotates the device a fitness application may be automatically enabled in the portable device 100. Thus, when the user context is determined as a physical activity, a fitness application may be activated. Consequently, operating S15 a context associated application comprises enabling an action relevant to the user context, which may represent a current activity of the user.

In some examples, the method of obtaining user input comprises restricting S17 access to one or more applications or data items in the portable device 100 at least in response to the second user input. Thus, the method may comprise restricting access to a plurality of data items in the device in response the first user input and/or the second input. The plurality of data items may include but not limited to a call application, an email application, a video application, a game application, an application icon, a menu component, a setting, a function or the like which are installed in the portable device 100. For example, when the user is about to lend his device to another person, a friend or unknown person, the user may like to restrict access the data items in the portable device 100. For example, restricting the access to the data items may include the amount of time the device can be used, the number of calls the other persons can make, which applications can be accessed, which applications should be restricted or the like. Optionally, different access rights could be stored in different profiles and different variants of at least the second user input, e.g., in combination with first user input, may be used to control which profile should be used. For example, the user may use one finger to swipe for friends, two fingers for unknown, three for a very restricted access when performing the gesturing movement of handing over the portable device 100 to a nearby user. Thus, the portable device 100 may be configured to restrict access to the plurality of data items in the device in response the first user input and/or the second input.

In some examples, the method comprises identifying S16a at least one connected device. The connected device may be pre-paired with context associated application or possible to paired with the context associated application in response to receiving the first user input. For example, the connected device can be a television, a head mounted display, HMD device, a smartwatch, a wearable device or the like. The connected device may be paired with the portable device 100 using any of the suitable communication protocols such as but not limited to Bluetooth, Wi-Fi, NFC or the like. When the portable device 100 is paired with the connected device, the connected device is identified and the connected device may be operated at least based on the second user input. In some examples, the connected device may of course also be operated based on a combination of touch input, i.e., first user input, and gesturing movements involving the portable device 100, i.e., second user input. The user can control the connected device using the portable device 100. For example, the user intends to bring up the menu (icons) on the TV and scroll to the movie of choice. As, the portable device 100 is paired with the TV (e.g. through Bluetooth or Wi-Fi), the portable device 100 acts as a remote pointing and control device which allows the user to move the portable device 100 to control a pointer on the TV screen. A subsequent touch on the touch detection area 102 may represent a selection function for the icon being pointed. Thus, the user can select a desired icon and accesses the icon in the connected device.

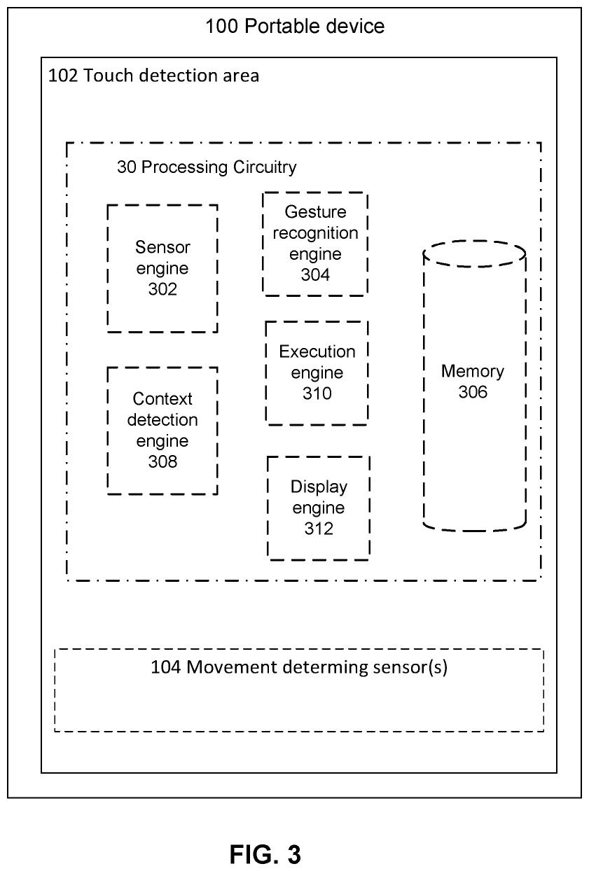

FIG. 3 illustrates an example schematic block diagram diagram illustrating an example configuration of a portable device 100, e.g., the portable device 100 of FIG. 1, implementing the above disclosed method. The portable device 100 comprises a touch detection area 102, one or more movement determining sensors 104, e.g., accelerometer, gyroscope, magnetometer, inertial sensors or the like for determining the movement of the device 100, and a processing circuitry 30. The processing circuitry 30 is configured to detect first user input on the touch detection area 102 within a time period, wherein the first user input is related to the application, and to register the movement of the portable device 100 within a predetermined space during the time period. Further, the processing circuitry 30 is configured to cause the application to receive a second user input during said time period, wherein the second user input is obtained from the registered movement.

The movement determining sensors 104 are arranged in the portable device 100 for tracking the various movements of the portable device 100. These movement determining sensors 104 register the complete movement of the portable device 100 (i.e., from an initial position of the portable device 100 to a final position) and the portable device 100, e.g., the application run on the portable device 100, is configured to interpret the registered movement as a second user input which may be proportional to the registered movement of the portable device 100 or interpreted using a gesture library of the application or a gesture library provided in the portable device 100 as illustrated in FIG. 3. The movement determining sensors 104 may be automatically deactivated, or receipt of input from the sensors may be deactivated, when the user terminates the movement of the portable device 100. Thus, the portable device 100 will be capable of detecting the touch gestures on the touch detection area 102, in combination with movements of the device by the one or more movement determining sensors 104, which causes the portable device 100 to respond to first user input and second user input.

The example configuration enables an application, e.g., a context associated application, to receive the first user input and/or the second user input. As depicted in FIG. 3, the portable device 100 includes a processing circuitry 30. The processing circuitry 30 may include a sensor engine 302, a gesture recognition engine 304, e.g., a gesture recognition engine having access to a gesture library, a memory 306, a context detection engine 308, an application execution engine 310, and a display engine 312.

In an embodiment, the sensor engine 302 may receive input from movement determining sensors 104, e.g., accelerometer, gyroscope, magnetometer, inertial sensor or any orientation detection sensor or the like for processing movement related user input for the portable device 100, e.g., second user input. The sensor engine 302 may be configured to continuously process movements of the portable device 102 when the user rotates, translates, flips or tilts the device in any direction within the pre-determined space, e.g., a space pre-determined as a reachable space for the user.

The gesture recognition unit 304 may be configured to recognize first user input (i.e., touch gesture) on the touch detection area 102 and within the pre-determined space (i.e., gesturing movement within a space outside the portable device 100). For example, the gesture recognition unit 304 may be configured to recognize the gesture as a touch gesture, a swipe gesture, a pinch gesture, a drag gesture, a rotate gesture, or the like. Thus, the gesture recognition unit 304 may be configured to identify the type of user input on the touch detection area, e.g., first user input. Further, the gesture recognition unit 304 may be configured to recognize gesturing movement of the portable device 100 i.e., the gesturing movement involving translation of the portable device 100, rotation of the portable device 100, a change in orientation of the portable device 100 or the like.

In an embodiment, the memory 306 includes a plurality of gestures registered with the portable device 100. For example, various user gestures such as but not limited to a touch gesture, a swipe gesture, a pinch gesture, a drag gesture, a rotate gesture, a zoom gesture, a tap gesture, a double tap gesture or the like may be stored in the memory 306. Additionally, the memory 306 includes a plurality of movements registered with the portable device 100. For example, the plurality of movements includes a forward, backward, upward and/or downward movement, a flip, a tilt, a clockwise rotation, an anticlockwise rotation or the like. The gesture recognition unit 304 may be communicatively coupled to the memory 306.

In an embodiment, a context detection engine 308 may be configured to determine the user context and determine a context associated application form the user context. The user context may be determined from one or more of a physical location, commercial location, and one or more connected devices of the user. The user context may also be determined from the first user input and/or second user input, e.g., from first user input activating an application on the portable device 100. The context detection engine 308 may also use a combination of first user input and second user input to determine the user context, e.g., an activation of a certain application through first user input and subsequent activation of an action using a gesturing movement. The context detection engine 308 may maintain a mapping relationship between the first user input and the second user input to determine the user context. For example, when the first user input is a swipe gesture and the second user input is a rotational movement of the portable device 100, then the context detection engine 308 combines the first input and the second input (i.e., the swipe gesture and the rotational movement) to determine the user context such as for example, the user is in a restaurant. Thus, the context detection engine 308 may be configured to combine the first user input and the second user input to detect the user context. The context detection engine 308 may also be trained with many combinations of the first input and the second input such that the context detection engine 308 stores various combinations of first user input and the second user input to determine user context.

In an embodiment, the execution engine 310 may be configured to execute or operate the application, e.g., the context associated application, in accordance with a determined user context. For example, when the user context is determined as boarding a cab (which is determined based on the first user input and the second user input), in response to determining the first user input and the second user input, the execution engine 310 may be configured to execute the cab application to enable the cab application to display a boarding card on the portable device 100. Thus, the execution engine 310 may be configured to execute or operate the context associated application in accordance with the determined user context. Additionally, the execution engine 310 may be configured to execute or operate various context associated applications which are relevant to the user context in response to the first user input and the second user input on the portable device 100.

The display engine 312 may be configured to provide the touch detection area 102 on the portable device 100. In an embodiment, the touch detection area 102 includes a touch panel or touchscreen on which the user performs one or more gestures.

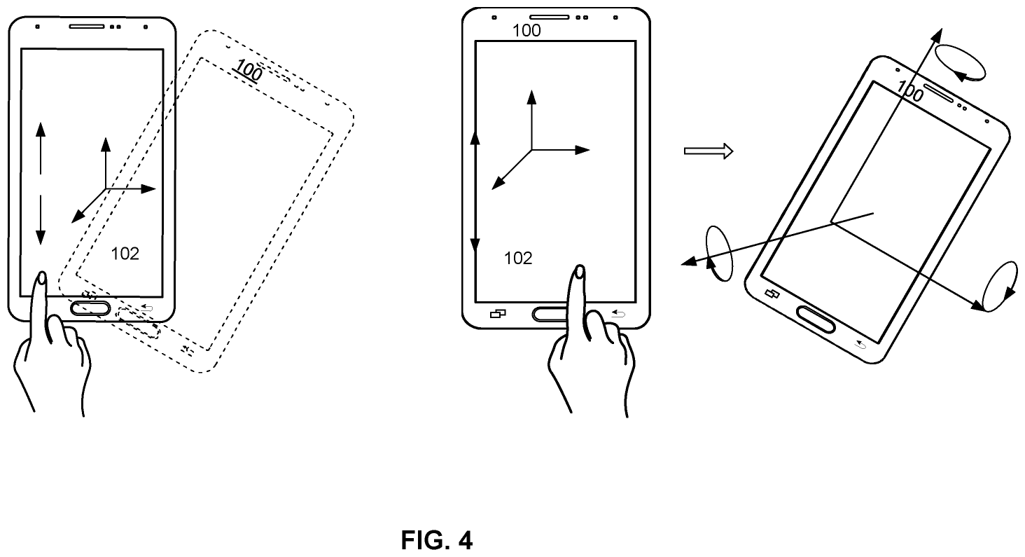

FIGS. 4 illustrates illustrate an example basic use case for obtaining user input at a portable device 100. In the basic case, a user may physically move the portable device with one hand, e.g., by holding on to the device, while one or more fingers (or a pointer) of the other hand are in contact with the touch detection area 102. A gesturing movement of the physical device in one direction, will result in a finger movement across the touch detection area 102 in an opposite direction causing the one or more fingers to make a swipe movement on the touch detection area 102. The gesturing movement is registered by the one or more movement determining sensors 104. When the one or more fingers leave the touch detection area 102, user input mode may be switched or expanded in the portable device so that second user input is retrieved from gesturing movements registered by the movement determining sensors 104. The portable device 100 may of course be configured to operate with a combination of first and second user input concurrently or to switch from first to second user input mode following an activating operation, e.g., the above disclosed swipe movement across the touch detection area 102. Activation of the gesture detecting mode may also require further distinctive gesturing of the portable device 100, i.e., moving the device in a given way to enable user input through an expanded gesture interface. Accordingly, a nature movement of the device causes the device to respond in a certain way, making the expanded user interface fast and intuitive.

As described for the basic use case of FIG. 4, first user input and second user input may be detected at least in part concurrently on the portable device 100. For example, the user performs a swipe gesture (i.e., a first input) on the touch detection area 102 and the user rotates the portable device 100 (i.e., the second user input) while performing the swipe gesture. Thus, the portable device 100 may be configured to receive the first user input and the second user input concurrently and the portable device 100 may be configured to enable the context associated application in response to detecting the first user input and the second user input concurrently on the portable device 100. Alternatively, provided detected sequentially on the portable device 100. For example, the user performs a swipe gesture (i.e., provides first user input) on the touch detection area 102 and only after having concluded the swipe gesture, the user rotates the device in a gesturing movement that provides the second user input.

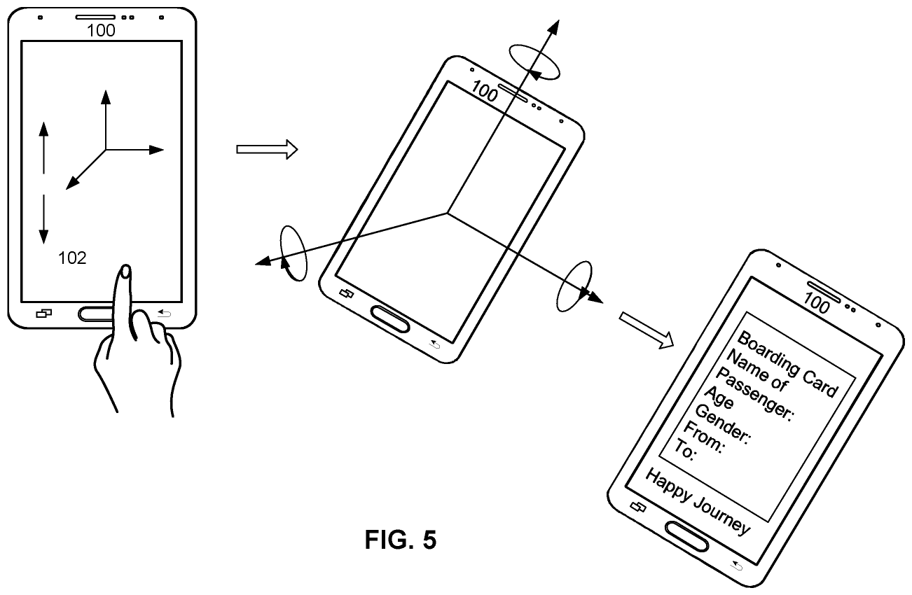

FIG. 5 illustrates an example use case for enabling an application on the portable device 100. The portable device 100, e.g., a wireless device, comprises a touch detection area 102, one or more movement determining sensors 104, e.g., accelerometer, gyroscope, magnetometer, inertial sensor or the like, and a processing circuitry. The user initially performs a swipe gesture on the touch detection area 102 to provide first user input and the finger continues to move on the touch detection area 102 until the perimeter of the touch detection area 102. The swipe to the perimeter of the touch detection area 102 may activate the ability to receive second user input in the form of gesturing movement as illustrated. The user rotates the portable device 100 after performing the swipe gesture on the touch detection area 102. When the user performs the swipe gesture (i.e., the first user input) and rotates (i.e., the second user input) the portable device 100, a determination of user context may also be activated, for example by from the first user input and/or the second user input, or by determining a physical or commercial location of the portable device. In this example, the portable device 100 may be configured to determine the user context as boarding a cab. After determining the user context, the portable device 100 may be configured to enable a cab booking application which is relevant to the user context, in response to the first user input and the second user input. Further, the portable device 100 may be configured to operate the cab booking application by displaying a boarding pass on the display of the portable device 100. In some examples, the boarding card application comprises a first user input to activate an application, a second user input in the form of a gesturing movement of the portable device 100 indicating that the device is shown to another person and an operating of the context associated application that results in a display of a boarding card.

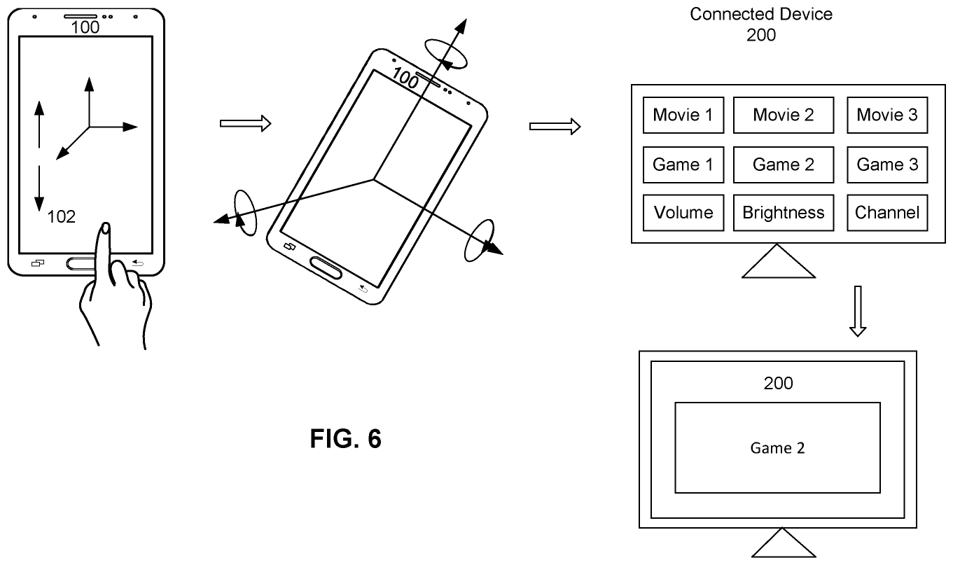

FIG. 6 illustrates another example use case for obtaining user input to a context associated application in a portable device 100 comprising a touch detection area 102 and one or more movement determining sensors 104. FIG. 6 discloses the user swiping a finger on the portable device 100, which is detected on the touch detection area 102 as a first user input. In the disclosed scenario, the user is engaged in an interaction with a connected device 200 such as for example, a television, TV and the user intends to want to display the menu (icons) on the TV and then scroll to a game for launching the game. The portable device 100, being a smartphone that may be pre-paired with the TV (e.g. Bluetooth or Wi-Fi or NFC) or connectable with the TV, acts as a remote pointing and control device which allows the user to move the portable device 100 and the movement of the portable device 100 controls the pointer on the TV screen.

As depicted in FIG. 6, the user initially performs a swipe gesture on the touch detection area 102 and the finger continues to move on the touch detection area 102 until reaching a perimeter of the touch detection area 102. The user then rotates the portable device 100 after performing the swipe gesture on the touch detection area 102. When the user performs the swipe gesture (i.e., the first user input) and rotates (i.e., the second user input), the portable device 100 configured to determine the user context as operating a connected device 200 (e.g., a TV-set). After determining the user context (e.g., to operate the TV), the first user input and the second user input on the portable device 100 enables or activates the menu system of the TV as further shown in FIG. 6. The combination of the first input and the second input may also enable a pointer in the middle of the screen of the TV that may be controlled by moving the portable device 100. Thus, the movement of the portable device 100, the user controls the pointer on the screen of the TV. The user clicks on a game to select the desired game (i.e., Game 2) and then the selected game can be played on the TV as shown in FIG. 6.

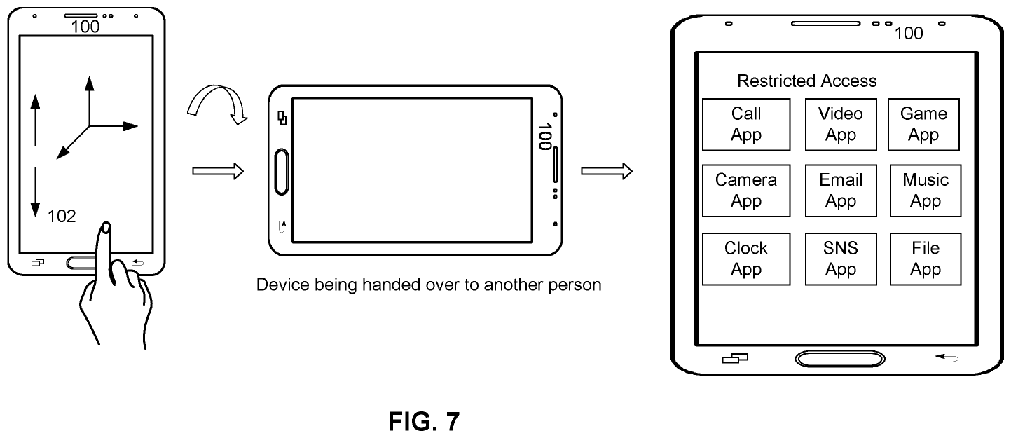

FIG. 7 illustrates another example use case for obtaining user input to a context associated application in a portable device 100 comprising a touch detection area 102 and one or more movement determining sensors 104. In the use case disclosed for FIG. 7, the combination of first and second user input may be used to restrict access to one or more applications or data items. The one or more applications include but are not limited to a call application, a video application, or a game application, a menu component, an icon, a setting, a function or the like which are installed in the portable device 100. In this example, the user is about to lend his portable device 100 to another person, a friend or unknown person and the user intends to restrict the access to the plurality of data items on the device. For example, the restrictions to the data items on the device may include the amount of time the other person can use the portable device 100, the number of calls the other person can make, the applications that can be accessed, the applications that can be blocked or the like. Alternatively, different access rights can be stored for different profiles and different variants of either the initial swipe and/or the movement gestures can be used to control which profile should be used, for example using one finger for friends, two for unknown, three for a very restricted access only allow the user to use the exact application which is currently active on the portable device 100.

As depicted in FIG. 7, the user may initially perform a swipe gesture on the touch detection area 102 and the user may perform a gesturing movement of the device as if the portable device 100 is being handed over to another person as shown in FIG. 7. When the user performs the swipe gesture (i.e., the first user input) and tilts or moves the portable device 100 (i.e., the second user input) as if the portable device 100 is handed over to another person. Further, the portable device 100 may be configured to determine the user context, for example by combining the first user input and the second user input. In this example, the portable device 100 may be configured to determine the user context as lending the device to another user. After determining the user context, the portable device 100 may be configured to restrict the data items, in response to the first user input and the second user input as shown in FIG. 7.

In the above disclosed use cases, benefits are achieved by enabling an expanded user interface, UI. The expanded UI is initiated by the user with a gesture, a touch, a movement or the like of the portable device 100 to cause the portable device 100 to retrieve user input from one or more movement determining sensors 104, thereby expanding outside the physical boundary the touch detection area 102. Thus, the expanded user interface may be activated by receiving first user input received on the touch detection area 102, by receiving second user input registered by one or more movement determining sensors 104 or by a combination of such user input.

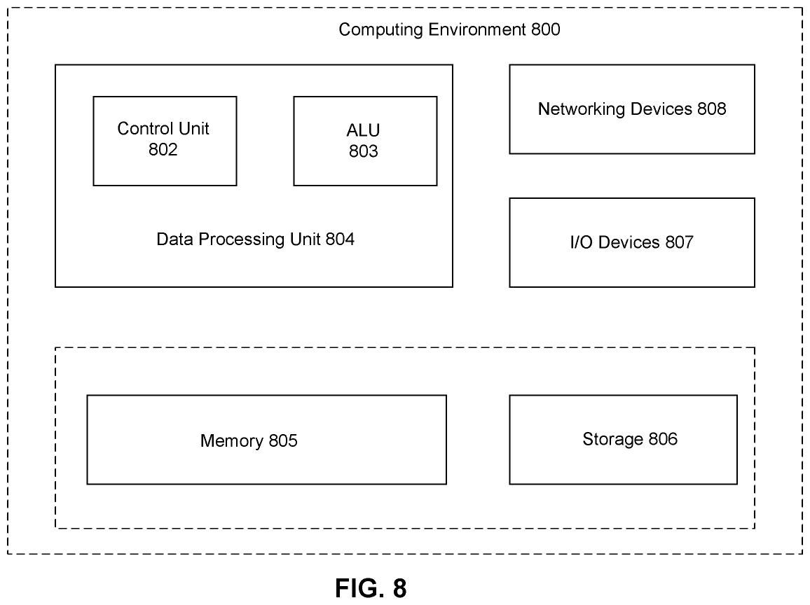

FIG. 8 illustrates an example computing environment implementing the method and portable device 100 for obtaining user input. While the portable device 100 has been illustrated as a wireless device in the above disclosed use cases and examples, it will be understood that the portable device 100 may be a number of portable applications, e.g., a smartphone, a table, a smart watch or a wearable device such as a glove or a shoe.

As depicted in FIG. 8, the computing environment 800 comprises at least one data processing unit 804 that is equipped with a control unit 802 and an Arithmetic Logic Unit (ALU) 803, a memory 805, a storage 806, plurality of networking devices 808 and a plurality Input output (I/O) devices 807. The data processing unit 804 is responsible for processing the instructions of the algorithm. The data processing unit 804 receives commands from the control unit in order to perform its processing. Further, any logical and arithmetic operations involved in the execution of the instructions are computed with the help of the ALU 803.

The overall computing environment 800 can be composed of multiple homogeneous and/or heterogeneous cores, multiple CPUs of different kinds, special media and other accelerators. The data processing unit 804 is responsible for processing the instructions of the algorithm. Further, the plurality of data processing units 804 may be located on a single chip or over multiple chips.

The algorithm comprising of instructions and codes required for the implementation are stored in either the memory 805 or the storage 806 or both. At the time of execution, the instructions may be fetched from the corresponding memory 805 and/or storage 806, and executed by the data processing unit 804.

In case of any hardware implementations various networking devices 808 or external I/O devices may be connected to the computing environment to support the implementation through the networking devices 808 and the I/O devices 807.

The embodiments disclosed herein can be implemented through at least one software program running on at least one hardware device and performing network management functions to control the elements. The elements shown in FIG. 8 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for obtaining user input to an application in a portable device comprising a touch detection area and one or more movement determining sensors, wherein the method comprises:
detecting first user input on the touch detection area within a time period, wherein the first user input is related to the application;
registering movement of the portable device within a predetermined space during said time period; and
causing the application to respond to second user input during said time period, wherein the second user input is obtained from the registered movement.

2. The method of claim 1, further comprising the step of:
activating the portable device and/or the application to respond to second user input.

3. The method of claim 2, wherein activating the portable device to respond to second user input comprises:
receiving, from the touch detection area, information relating to user activity in a direction toward a perimeter of the touch detection area; and/or
detecting first user input at a perimeter of the touch detection area.

4. The method of claim 1, wherein the second user input is a gesturing movement of the portable device within reach of the user and wherein the second user input is obtained by retrieving at least one gesture interpretation from a gesture library and applying the gesture interpretation to the gesturing movement.

5. The method of claim 1, wherein the application is a context associated application determined from a user context, wherein the user context is determined from one or more of a physical location, commercial location, and connected device of the user.

6. The method according to claim 1, wherein the step of activating the portable device to respond to second user input comprises enabling the context associated application.

7. The method of claim 5, further comprising:
operating the context associated application based on at least the second user input.

8. The method according to claim 1, wherein the first input and the second input are detected at least in part concurrently on the portable device during the time period.

9. The method according to claim 1, wherein the first input and second input are detected at least in part sequentially on the portable device, wherein the first user input is detected at a time instance initiating the time period.

10. The method according to claim 1, wherein registering movement of the portable device within a predetermined space during the time period comprises;
detecting a change in one or more parameters representative of translation and/or rotation of the portable device using the one or more motion determining sensors.

11. The method according to claim 1, wherein the method further comprises:
identifying at least one connected device, the connected device being pre-paired with context associated application; and
operating the connected device, in response to the second user input.

12. The method according to claim 1, wherein the method further comprises:
restricting access to one or more applications or data items in the portable device in response to the second user input.

13. A computer program product comprising a non-transitory computer readable medium, having thereon a computer program comprising program instructions, the computer program being loadable into a processing circuitry and configured to cause execution of the method according to claim 1 when the computer program is run by the processing circuitry.

14. A portable device comprising a touch detection area, one or more movement determining sensors, and processing circuitry, wherein the processing circuitry is configured to:
detect first user input on the touch detection area within a time period, wherein the first user input is related to the application;
register movement of the portable device within a predetermined space during said time period; and
cause the application to respond to second user input during said time period, wherein the second user input is obtained from the registered movement.

15. The device of claim 14, wherein the portable device is a smartphone, a tablet, a smartwatch or a wearable device.
